(19) United States
(12) Patent Application Publication
(10) Pub. No.: US 2002/0041679 A1
(43) Pub. Date: Apr. 11, 2002

(54) Method and apparatus for minimizing far-end speech effects in hands-free telephony systems using acoustic beamforming

(76) Inventor: Franck Beaucoup, Kanata (CA)

Correspondence Address: William J. Sapone, Esq., Coleman Sudol Sapone P.C., 714 Colorado Avenue, Bridgeport, CT, 06605, US

(21) Appl. No.: 09/971,225

(22) Filed: Oct. 3, 2001

(30) Foreign Application Priority Data
Oct. 6, 2000 (GB) 0024582.9

(51) Int. Cl. H04M 9/08

(52) U.S. Cl. 379/406.01

(57) ABSTRACT

A far-end activity detector for use in a hands-free telephone incorporating a beamformer, comprising a pair of accumulators for storing respective samples of a near-end signal and a far-end signal received by the hands-free telephone, a pair of modules for calculating the acoustic energies of the respective samples of the near-end signal and the far-end signal, and a comparator for comparing the acoustic energies and in the event the far-end acoustic energy exceeds the near-end acoustic energy by more than said predetermined amount then freezing operation of the steering functionality of the beamformer.

### FIELD OF THE INVENTION

The present invention relates generally to telephony systems and in particular to a method and apparatus for minimizing the effects of far-end speech on beamformer operation in a hands-free environment.

### BACKGROUND OF THE INVENTION

Localization of sources is required in many applications, such as teleconferencing, where the source position is used to steer a high quality microphone beam toward the talker. In video conferencing systems, the source position may additionally be used to focus a camera on the talker.

It is known in the art to use electronically steerable arrays of sensors in combination with location estimator algorithms to pinpoint the location of a talker in a room (see Adaptive Filter Theory, 3^{rd} edition. Simon Haykin, Prentice Hall, 1996. ISBN 0-13-322-760-X). This talker localization functionality can be implemented either as a separate module feeding the beamformer with the talker position (see commonly assigned UK patent application no. 0016142.2, entitled Acoustic Talker Localization by Maziar Amiri, Dieter Schulz, Michael Tetelbaum) or as part of an adaptive beamforming algorithm (see U.S. Pat. No. 4,956,867 entitled Adaptive Beamforming for Noise Reduction). In this way, high quality and complex beamforners have been used to measure the power at different positions. Estimator algorithms locate the dominant audio source using power information received from the beamformers.

Attempts have been made at improving the performance of prior art beamformers by enhancing acoustical audibility using filtering, etc. The foregoing prior art methodologies are described in Speaker localization using a steered Filter and sum Beamformer, N. Strobel, T Meier, R. Rabenstein , presented at the Erlangen work shop 99, vision, modeling and visualization, Nov. 17-19th, 1999, Erlangen, Germany.

Irrespective of the beamformer implementation, talker localization is affected by far-end speech, which can be annoying for the far-end talker when speech resumes at the near end. More precisely, if the system steers the beam towards a different location than the near end talker (e.g. corresponding to either the direct or an indirect path from the speakerphone to the microphone array) during far-end speech, a period of time is required before the device is able to steer the array back to the near-end talker when near-end speech resumes. The acoustic quality of the near-end signal output by the beamformer is adversely affected during that time period. Furthermore, this spurious switching of the source position may affect otherwise useful statistics about the positions which have been localized or identified as talkers by the device.

A number of publications have addressed the issue of two-way communication systems using beamforming (e.g. Strategies for Combining Acoustic Echo Cancellation and Adaptive Beamforming Microphone Arrays by W. Kellermann. Proc. IEEE ICASSP, vol. 1. 1997 is a study of the effect of beamforming on accoustic echo cancellation). However none of these publications discuss the influence of far-end voice activity on talker localization. Many other publications relate to acoustic beamforming with one-way communication only, where there is no far-end speech.

### SUMMARY OF THE INVENTION

The present invention provides a solution to the problem of far-end speech affecting operation of the beamforming device. It should be noted that this problem arises both in half-duplex and full-duplex communication systems, both of which are addressed by the present invention.

According to the present invention, a mechanism is provided that freezes the steering functionality of the beamforming device during far-end speech. In particular, a far-end activity detector is embedded in the beamforming device. The steering of the beam is frozen as soon as the activity detector indicates that the far-end signal energy is high relative to the near-end signal energy. The steering resumes as soon as the far-end speech stops and near-end speech resumes.

### BRIEF DESCRIPTION OF THE DRAWINGS

A preferred embodiment of the present invention will now be described more fully with reference to the accompanying drawings in which:

FIG. 1 is a block diagram of a beamforming device incorporating the system according to the present invention; and

FIG. 2 is a block diagram of a far-end activity detector according to a preferred embodiment of the invention.

### DETAILED DESCRIPTION OF THE PREFERRED EMBODIMENT

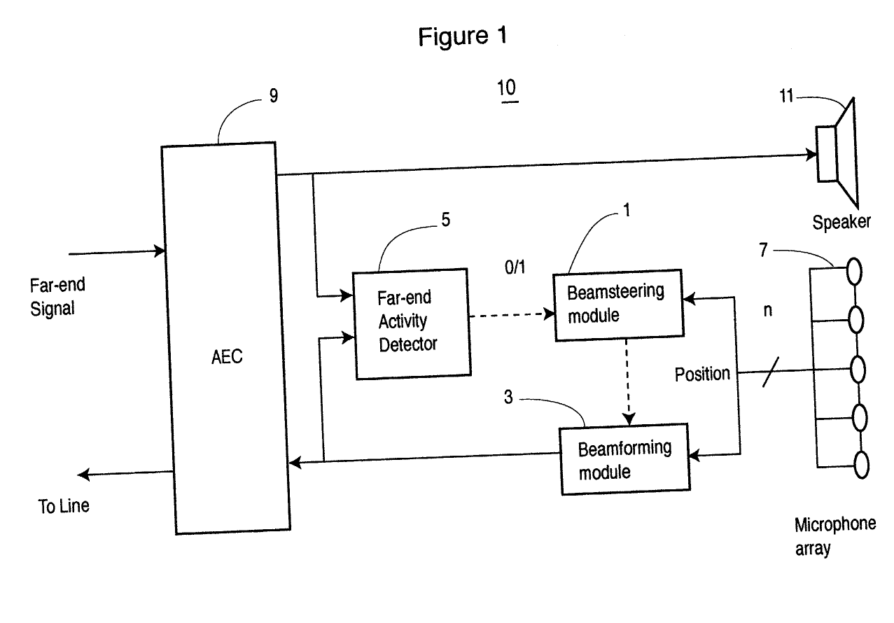

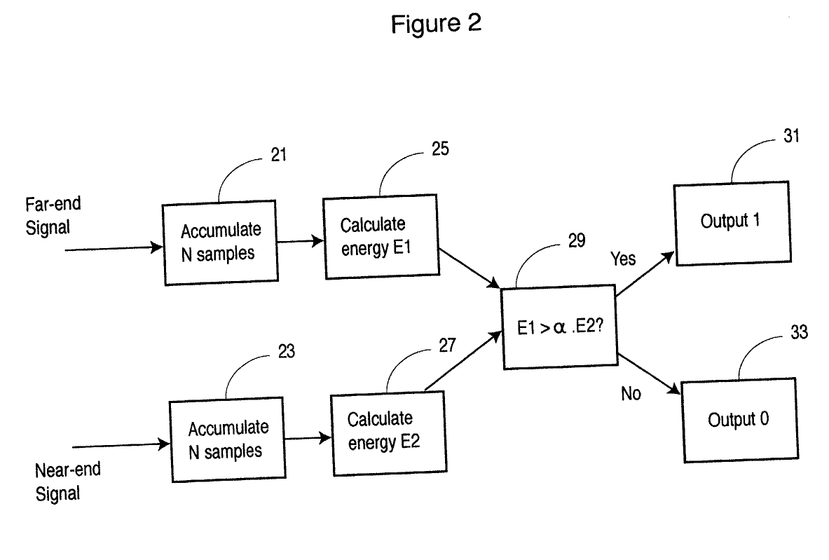

With reference to FIG. 1, a hands-free telephone is shown incorporating a beamforming device. In the illustrated embodiment the beamforming device is implemented as two separate modules: a beamsteering module 1 for the steering, and a beamforming module 3 for forming the beam. Alternatively, an adaptive beamformer may be used which combines the beamsteering and beamforming functions. In order to freeze the steering functionality of the beamforming device during far-end speech, the beamsteering module I receives a signal from the output of an activity detector 5 which scans both the far-end and the near-end signals, as described in greater detail below with reference to FIG. 2. The function of the activity detector is to indicate periods of far-end activity or, more precisely, periods where the far-end signal energy is high relative to the near-end signal energy.

In the hands-free arrangement of FIG. 1, a microphone array 7 is represented as a linear array, although any array geometry may be used for implementing the present invention. An Acoustic Echo Cancellation (AEC) block 9 is provided to maximize the speech quality for the far-end talker by means of canceling acoustic echo that arises in the near-end hands-free environment. A speaker 11 is provided for reproducing the far-end speech signal, in a well-known manner.

The details of the far-end activity detector of the preferred embodiment are set forth in FIG. 2. Samples of a few milliseconds of the far-end and near-end signals are accumulated in modules 21 and 23. For each such time interval, short-term energies are calculated in modules 25 and 27, and are compared to each other in module 29. If the far-end energy is greater than the near-end energy times a predetermined threshold (which depends on the output level of the speaker 11) then the activity detector outputs a 1 (i.e. a logic high signal) from block 31, otherwise it outputs 0 (i.e. a logic low signals) from block 33. These outputs are applied to the beamsteering module 1. If the output is 1 then steering is frozen until the beamsteering module receives a 0 output from block 33 the activity detector 5.

It should be noted that, if the user adjusts the speaker volume during a hands-free conversation, the aforementioned threshold must be adjusted accordingly, in real time.

Many acoustic echo cancellation algorithms, whether they are half-duplex or full-duplex, already incorporate activity detectors for the far-end signal (see commonly assigned U.S. Pat. No 4,796,287 entitled Digital Loudspeaking Telephone, and U.S. Pat. No. 5,706,344 entitled Acoustic Echo Cancellation in an Integrated Audio and Telecommunication System). For full-duplex systems, where an adaptive algorithm is used to fit a model to the acoustic echo path, it may be desirable that no adaptation be done in the absence of far-end speech (that is, in the absence of a sufficiently loud reference signal). If such an algorithm is already used in the system, then the far-end activity detector 5 can simply reuse some of the internal results (such as short-term energies) already calculated. In such an application, the implementation of the present invention contributes virtually no additional cost in terms of complexity.

Alternatives and variations of the invention are possible. For example, the actual structure of the far-end activity detector 5 can be different from the preferred embodiment set forth above with reference to FIG. 2. Many variations are possible as long as the function of the far-end activity remains to indicate periods where the far-end signal energy is high relative to the near-end signal energy. For instance, the near-end signal fed to the far-end activity detector 5 does not have to be the output of the beamforming module 3, as shown in FIG. 1. It can be any combination of the microphone inputs 7, provided that the activity detector 5 continues to function as set forth above.

As discussed above, the beamforming device in the implementation of the invention shown in FIG. 1, may be in the form of two separate modules for steering and for forming of the beam, or in the form of an adaptive beamformer which combines the two functions. For the adaptive beamformer implementation, the output of the far-end activity detector 5 is fed directly to the beamformer itself so that the whole adaptation process is frozen during far-end speech activity periods.

All such embodiments, modifications and applications are believed to be within the sphere and scope of the invention as defined by the claims appended hereto.

We claim:

1. A method of minimizing the effects of far-end speech on beamformer operation in a hands-free environment, comprising the steps of:
receiving at least respective portions of a far-end signal and a near-end signal;
calculating the respective signal energies of said portions;
comparing said signal energies and in the event the signal energy of the far-end signal exceeds the energy of the near-end signal by more than a predetermined amount then freezing operation of at least a beam steering function of said beamformer.

2. A hands-free telephone incorporating a beamformer, comprising:
an echo canceller for canceling echo signals resulting from far-end signals in the acoustical environment of the hands-free telephone;
a speaker connected to the echo canceller for broadcasting said far-end signals;
a microphone array for receiving near-end signals from a talker in said acoustical environment;
a beamformer for locating the position of said talker and in response steering said microphone array toward said talker; and
a far-end activity detector for freezing at least said steering of said microphone by said beamformer in the event that the far-end signal exceeds the near-end signal by more than a predetermined amount.

3. The hands-free telephone of claim 2, wherein said beamformer comprises a beamforming module for locating the position of said talker, and a beamsteering module for steering said microphone array.

4. The hands-free telephone of claim 3, wherein said far-end activity detector is connected to said beamformer module for freezing said steering of said microphone array in the event that the far-end signal exceeds the near-end signal by more than said predetermined amount.

5. The hands-free telephone of claim 2, wherein said beamformer is an adaptive beamformer for performing dual functions of locating the position of said talker and steering said microphone array.

6. The hands-free telephone of claim 5, wherein said far-end activity detector is connected to said adaptive beamformer for freezing both said locating of the position of said talker and said steering of said microphone in the event that the far-end signal exceeds the near-end signal by more than said predetermined amount.

7. The hands-free telephone of any one of claims 2 to 6, wherein said far-end activity detector further comprises:
a pair of accumulators for storing respective samples of said near-end signal and said far-end signal;
a pair of modules for calculating the acoustic energies of said respective samples of said near-end signal and said far-end signal; and
a comparator for comparing said acoustic energies and in the event the far-end acoustic energy exceeds the near-end acoustic energy by more than said predetermined amount then freezing at least said steering of said microphone by said beamformer.

8. A far-end activity detector for use in a hands-free telephone incorporating a microphone array and a beamformer for locating the position of a talker and in response steering said microphone array toward said talker, comprising:
a pair of accumulators for storing respective samples of a near-end signal and a far-end signal received by said hands-free telephone;
a pair of modules for calculating the acoustic energies of said respective samples of said near-end signal and said far-end signal; and
a comparator for comparing said acoustic energies and in the event the far-end acoustic energy exceeds the near-end acoustic energy by more than said predetermined amount then freezing at least said steering of said microphone array.
